(19) United States
(12) Patent Application Publication
(10) Pub. No.: US 2008/0111656 A1
(43) Pub. Date: May 15, 2008

(54) Method and apparatus for magnetically treating fluids

(75) Inventor: Peter Kulish, New Hope, PA (US)

Correspondence Address: ROBERT M. DOWNEY, P.A., 6751 N. FEDERAL HWY., SUITE 300, BOCA RATON, FL, 33487, US

(73) Assignee: Foundation for Magnetic Science

(21) Appl. No.: 11/598,504

(22) Filed: Nov. 13, 2006

(51) Int. Cl. H01F 7/02

(52) U.S. Cl. 335/306

(57) ABSTRACT

A method and apparatus for applying a magnetic flux to a fluid flowing through a conduit is described. The apparatus comprises a flux driver plate having a plate base and sides extending upwardly from the plate base at angles greater than ninety degrees. A plurality of permanent magnets is affixed longitudinally along the plate base between the driver plate sides to generate the magnetic flux to treat the fluid. The magnetic flux can be enhanced by the addition of a flux recircuiting receiver plate over the magnets and the flux driver plate.

### BACKGROUND OF THE INVENTION

1. Field of the Invention

The present invention relates to magnetohydrodynamics and more particularly to the magnetic treatment of fluids flowing through a conduit.

2. Discussion of the Related Art

Magnetic fluid conditioning, also referred to as magnetohydro-dynamics MHD) is the interaction of electrically conducting fluids with a magnetic field and is well known in the art. MHD has been studied and is the subject of numerous patents throughout the world. A number of studies indicate that MHD is an effective method to enhance and soften fluids such as water for the purpose of loosening and preventing scale from water pipes and water process equipment such as boilers, heat exchangers, cooling towers, heaters and the like. Studies also suggest that MHD reduces chemical needs in pools and spas as well as reducing biological encrustations and bacterial counts. MHD has also been tested and used by NASA as a method to improve combustion efficiency of fuels and it is suggested that MHD beneficially increases the efficiency of refrigeration systems and fluid transport in transmission lines and wells.

Numerous magnetic devices of a variety of configurations have been developed to apply a magnetic field to water, fuel or other fluids flowing through a conduit or pipe. All of these devices have met with varying degrees of success and there is little doubt that MHD is a low cost and efficient technology for “conditioning” many types of fluids. Despite its obvious utility, MHD has not reached wide popularity, especially in the United States. This is believed to be because there was an early lack of scientific knowledge of magnetic fluid dynamics and the corresponding magnetic field strength required to condition the fluids. Primarily, the early developed systems did not employ enough magnetic field strength and therefore did not show consistent results.

Thus what is desired is an improved MHD method and apparatus to beneficially treat fluids such as water, fuel, coolants, biological material and chemical mixtures.

### SUMMARY OF THE INVENTION

One embodiment of the present invention is an apparatus for applying a magnetic flux to a fluid flowing through a conduit. The apparatus comprises a ferrous flux driver plate having a plate base and sides extending upwardly from the plate base at angles greater than ninety degrees. A plurality of permanent magnets of the same polar orientation axially directed toward the fluid conduit is affixed longitudinally along the plate base between the driver plate sides to generate the magnetic flux to treat the fluid. The magnetic flux can be enhanced by longitudinally separating the magnets to form a gap between adjacent magnets. The flux can be further enhanced by placing a ferrous flux recircuiting receiver plate over the magnets and the flux driver plate.

Another embodiment of the present invention for applying a magnetic flux to a fluid flowing through a conduit is an apparatus having a ferrous flux driver plate at least two rows of permanent magnets of the same polar orientation directed axially toward the fluid conduit arranged thereon. The flux driver plate has a plate base and a magnet base extending from each side thereof at a magnet base angle and further having a driver plate side extending from the magnet base at a side angle therefrom. The magnet base angle and the side angle are each greater than ninety degrees. Alternatively, the flux driver plate and magnets can be arcuate in shape. The magnetic flux can be enhanced by longitudinally separating the magnets in each row to form a longitudinal gap between longitudinally adjacent magnets and also by separating the magnet rows to form a lateral gap between laterally adjacent magnets. The flux can be further enhanced by placing a ferrous flux recircuiting receiver plate over the magnets and the flux driver plate.

Also described is a method for magnetically treating fluids flowing through a conduit by arranging a plurality of permanent magnets of substantially equal flux in a longitudinally aligned row with poles of the same polar orientation directed axially toward the fluid conduit in the same direction. The magnets are then affixed to a base plate of a flux driver plate and forming the sides of the flux driver plate at an angle greater than ninety degrees with respect to the base plate. The combined magnets and flux driver plate are then aligned with the fluid conduit and placed proximate to it. The magnetic flux induced on the fluid can be enhanced by registering a ferrous flux recircuiting receiver plate over the fluid conduit, longitudinally aligned magnets, and flux driver plate and by separating side edges of the recircuiting receiver plate from side edges of the flux driver plate to define a variable gap therebetween.

These and other advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a partially exploded perspective view of an apparatus for treating fluids embodying the present invention;

FIG. 2 is a side view of the apparatus show in FIG. 1;

FIG. 3 is a partially exploded perspective view of an alternate embodiment of the apparatus shown in FIG. 1;

FIG. 4 is a partially exploded perspective view of yet another alternate embodiment of the apparatus shown in FIG. 1;

FIG. 5 is a partially exploded perspective view of an alternate embodiment incorporating an arcuate flux driver plate.

Like reference numerals refer to like parts throughout the several views of the drawings.

### DETAILED DESCRIPTION OF THE PREFERRED EMBODIMENTS

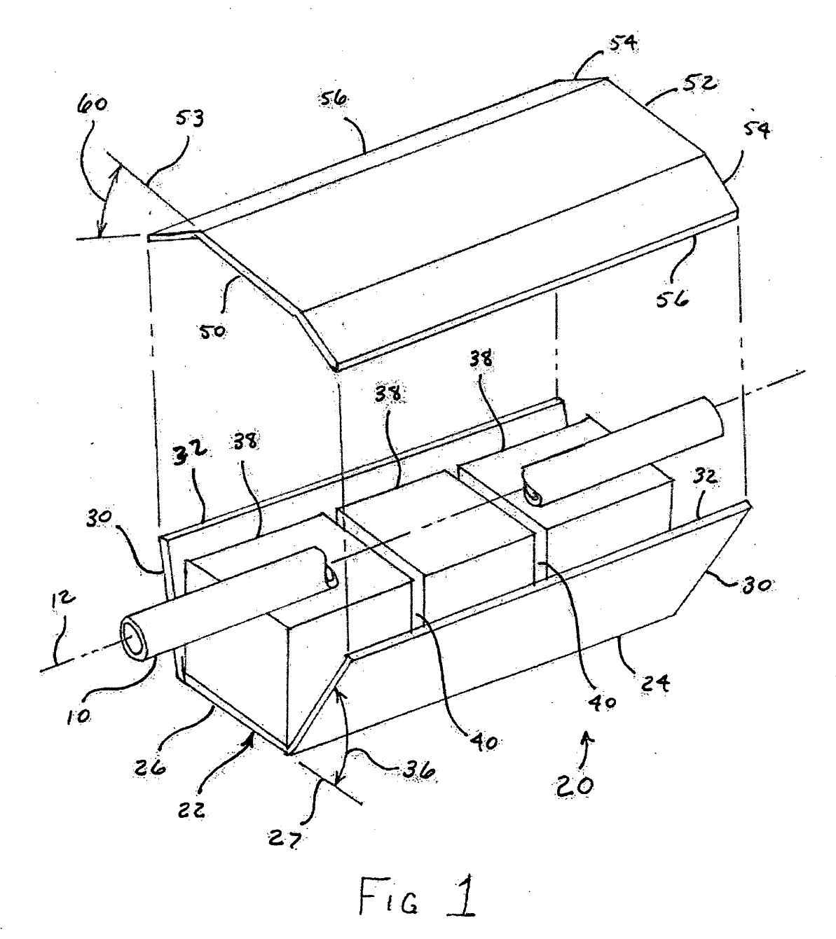

For purposes of description herein, the terms “upper”, “lower”, “left”, “rear”, “right”, “front”, “vertical”, “horizontal”, and derivatives thereof shall relate to the invention as oriented in FIG. 1. However, one will understand that the invention may assume various alternative orientations and step sequences, except where expressly specified to the contrary. While the present invention has been shown and described in accordance with preferred and practical embodiments thereof, it is recognized that departures from the instant disclosure are fully contemplated within the spirit and scope of the invention. Hence, specific dimensions and other physical characteristics relating to the embodiments disclosed herein are not to be considered as limiting, unless the claims expressly state otherwise.

Turning to the drawings, FIG. 1 shows an apparatus 20 for magnetically treating fluids which is one of the preferred embodiments of the present invention and illustrates its various components. The apparatus 20 comprises a magnetic driver 22 and a flux recircuiting receiver plate 50. Magnetic driver 22 includes a flux driver plate 24 which comprises a driver plate base 26 and driver plate sides 30 affixed to driver plate base 26. Flux driver plate 24 is fabricated from a ferrous material such as steel. Driver plate base 26 defines a plate base plane 27 wherein driver plate sides 30 define a side angle 36 with respect to plate base plane 27. The side angle 36 formed by driver plate side 30 and plane 27 is a minimum of five degrees and a maximum of eighty-five degrees. Thus, the angle formed between driver plate base 26 and each driver plate side 30 is between ninety-five and one-hundred-seventy five degrees. Driver plate sides 30 also define side edges 32 at the uppermost part of driver plate sides 30.

A plurality of permanent solid state magnets 38 having substantially identical field strengths are longitudinally arranged on and affixed to plate base 26 between driver plate sides 30. (FIG. 1 illustrates the positioning of three magnets 38 on plate base 26; however, this is for illustrative purposes only and is not intended to be interpreted as limiting.) Magnets 38 are in a unipolar arrangement such that either all north poles or all south poles of magnets 38 are oriented upwardly with the opposing like poles affixed to plate base 26. Longitudinally arranged magnets 38 are spaced to define a longitudinal gap 40 of at least one one-thousandth of an inch between each of adjacent ones of magnets 38.

A flux recircuiting receiver plate 50, also fabricated from a ferrous material such as steel, has a center section 52 that defines a plane 53 and also has receiver plate sides 54 that are formed to define a receiver side angle 60 with respect to plane 53. The angle 60 so formed is not less than ten degrees and not greater than eighty-five degrees. Thus, the angle formed by center section 52 and receiver plate side 54 is between one-hundred and one-hundred-seventy-five degrees. Receiver plate sides 54 further define at their outermost extremities receiver plate side edges 56.

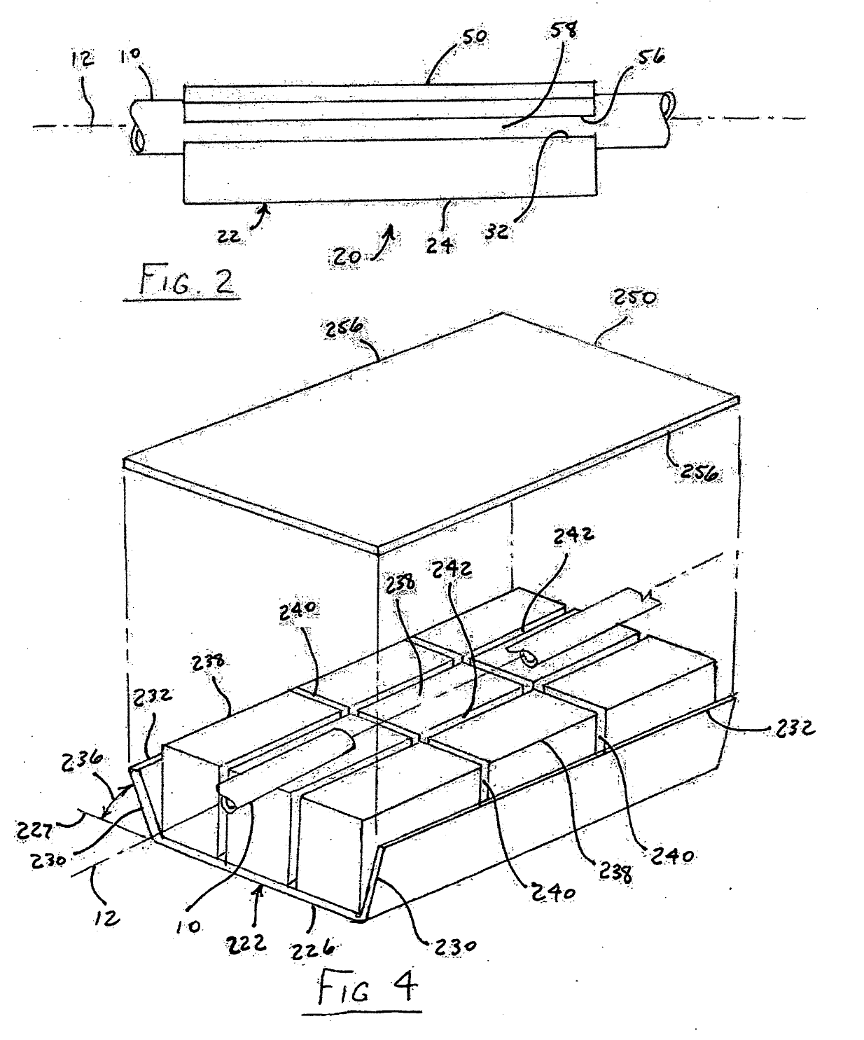

The magnetic driver 22 is placed adjacent to a fluid conduit 10 such that the longitudinally arranged magnets 38 are substantially parallel to the flow axis 12 of fluid conduit 10 and such that fluid conduit 10 is most proximate to the segments of the magnets 38 opposite from the driver plate base 26. Flux recircuiting receiver plate 50 is placed over fluid conduit 10 and substantially in vertical registration with flux driver plate 24. The assembled apparatus 20 is then clamped in place on the fluid conduit 10. As shown in FIG. 2, when apparatus 20 is clamped to fluid conduit 10, side edge 32 and receiver plate side edge 57 are substantially parallel one with the other and define therebetween a variable gap 58 of at least one one-thousandth of an inch.

In operation, the apparatus 20 is clamped to fluid conduit 10 as described above. Fluid is then passed through fluid conduit 10 along longitudinal flow axis 12 to pass through the combined magnetic fields of permanent magnets 38. Longitudinal gaps 40 between individual magnets 38 and the single angled ferrous flux driver plate 24 cooperate to increase the magnetic field density into the fluid flowing through conduit 10. Further, flux recircuiting receiver plate 50 increases the magnetic flux field density into the fluid by pulling the magnetic flux lines from the magnetic driver 22 through the fluid.

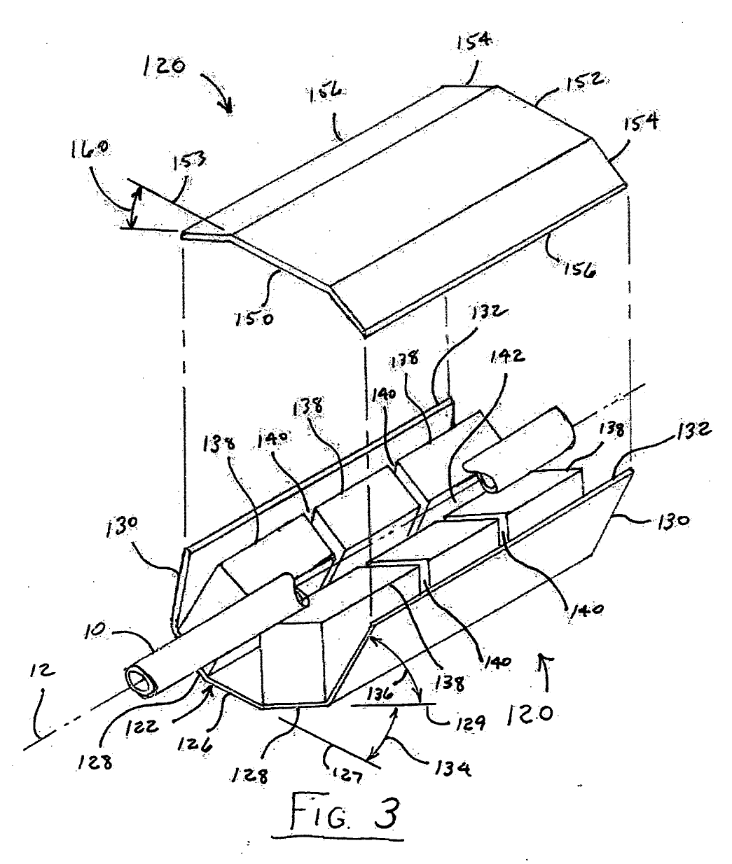

Turning now to FIG. 3, an alternative apparatus 120 for magnetically treating fluids is illustrated. Apparatus 120 is similar to apparatus 20 and like features are identified with like numbers preceded by the numeral “1.” The apparatus 120 comprises a magnetic driver 122 and a flux recircuiting receiver plate 150. Magnetic driver 122 includes a flux driver plate 124 which comprises a driver plate base 126, magnet base 128 affixed to driver plate base 126, and driver plate sides 130 affixed to magnet base 128. Flux driver plate 124 is fabricated from a ferrous material such as steel. Driver plate base defines a plate base plane 127 and magnet base 128 defines a magnet base plane 129. Each magnet base 128 defines a magnet base angle 134 with respect to plate base plane 127. The magnet base angle 134 is a minimum of five degrees and a maximum of sixty-five degrees. Thus, the angle formed between driver plate base 126 and each magnet base 128 is between one-hundred-fifteen and one-hundred-seventy five degrees. Similarly, Driver plate sides 130 define a side angle 136 with respect to magnet base plane 129. The side angle 136 formed thereby is a minimum of one degree and a maximum of eighty degrees. Thus, the angle formed between magnet base 128 and each driver plate side 130 is between one-hundred and one-hundred-seventy nine degrees. Driver plate sides 130 also define side edges 132 at the uppermost part of driver plate sides 130.

A plurality of permanent solid state magnets 138 having substantially identical field strengths are arranged in two longitudinally parallel rows, each row being affixed to one of the magnet bases 128 and between driver plate sides 130. (FIG. 3 illustrates the positioning of six magnets 138 on magnet bases 128; however, this is for illustrative purposes only and is not intended to be interpreted as limiting.) Magnets 138 are in a unipolar arrangement such that either all north poles or all south poles of magnets 138 are oriented upwardly with the opposing like poles affixed to magnet bases 128. Longitudinally arranged magnets 138 are spaced to define a longitudinal gap 140 of at least one one-thousandth of an inch between each of longitudinally adjacent magnets 138, and adjacent rows of magnets 138 are spaced to define a lateral gap 142 of at least one one-thousandth of an inch between laterally adjacent magnets 138.

Similar to apparatus 20, a flux recircuiting receiver plate 150, also fabricated from a ferrous material such as steel, has a center section 152 that defines a plane 153 and also has receiver plate sides 154 that are formed to define a receiver side angle 160 with respect to plane 153. The angle 160 so formed is not less than ten degrees and not greater than eighty-five degrees. Thus, the angle formed by center section 152 and receiver plate side 154 is between one-hundred and one-hundred-seventy-five degrees. Receiver plate sides 154 further define at their outermost extremities receiver plate side edges 156.

In use, apparatus 120 is affixed to fluid conduit 10 in the same manner as apparatus 20 with magnetic driver 122 placed below fluid conduit 10 such that the rows of magnets 138 are parallel to flow axis 12 of conduit 10, and such that fluid conduit 10 is most proximate to the segments of the magnets 138 opposite from the magnet base 128. Flux recircuiting receiver plate 150 is placed over fluid conduit 10 and substantially in vertical registration with flux driver plate 124. The assembled apparatus 120 is then clamped in place on the fluid conduit 10. Similar to apparatus 20 shown in FIG. 2, when apparatus 120 is clamped to fluid conduit 10, side edge 132 and receiver plate side edge 157 are substantially parallel one with the other and define therebetween a variable gap of at least one one-thousandth of an inch similar to variable gap 58.

In operation, apparatus 120 is clamped to fluid conduit 10 as described above. Fluid is then passed through fluid conduit 10 along longitudinal flow axis 12 to pass through the combined magnetic fields of permanent magnets 138, wherein the combined magnetic fields of magnets 138 cooperate with flux driver plate 124 and flux recircuiting receiver plate 150 to provide an advantageous magnetic flux to the fluid.

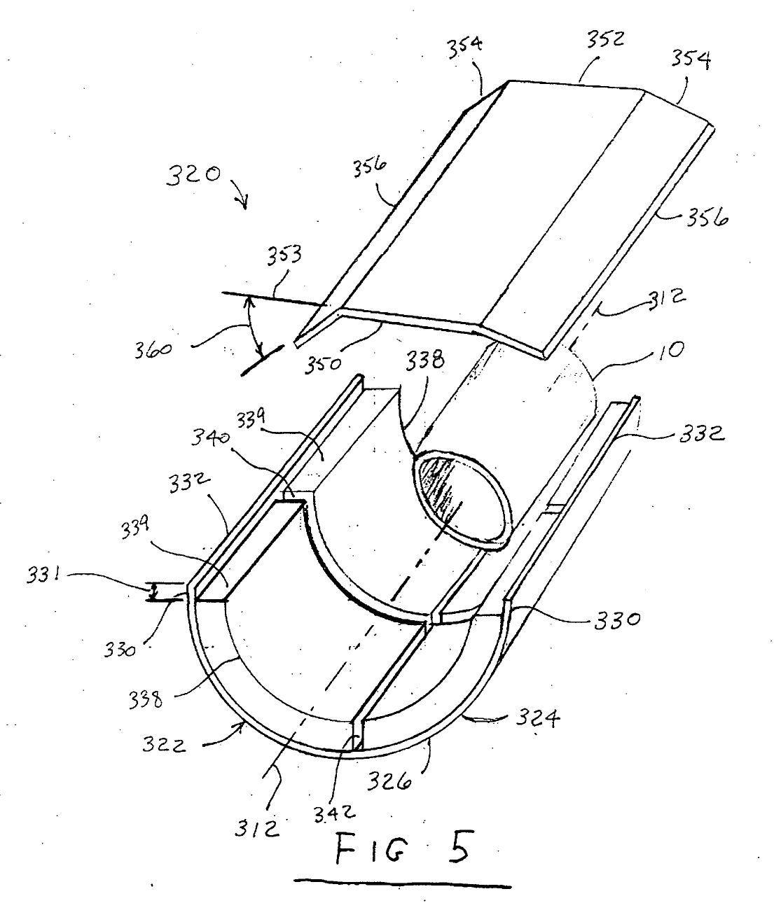

FIG. 4 illustrates yet another embodiment of apparatus 220. Apparatus 220 is similar to apparatus 20 and like features are identified with like numbers preceded by the numeral “2.” The apparatus 220 comprises a magnetic driver 222 and a flux recircuiting receiver plate 250. Magnetic driver 222 includes a flux driver plate 224 which comprises a driver plate base 226 and driver plate sides 230 affixed to driver plate base 226. However, driver plate base 226 is substantially wider than driver plate base 26 of apparatus 20. Flux driver plate 224 is fabricated from a ferrous material such as steel. Driver plate base 226 defines a plate base plane 227 wherein driver plate sides 230 define a side angle 236 with respect to plate base plane 227. The side angle 236 formed by driver plate side 230 and plane 227 is a minimum of five degrees and a maximum of eighty-five degrees. Driver plate sides 230 also define side edges 232 at the uppermost part of driver plate sides 230.

A plurality of permanent solid state magnets 238 having substantially identical field strengths are arranged in a plurality of longitudinally parallel rows, each row being affixed to plate base 226 between driver plate sides 230. (FIG. 3 illustrates the positioning of nine magnets 138 in three rows on plate base 226; however, this is for illustrative purposes only and is not intended to be interpreted as limiting.) Magnets 238 are in a unipolar arrangement such that either all north poles or all south poles of magnets 238 are oriented upwardly with the opposing like poles affixed to plate base 226. Longitudinally arranged magnets 238 are spaced to define a longitudinal gap 240 of at least one one-thousandth of an inch between each of longitudinally adjacent magnets 238, and adjacent rows of magnets 238 are spaced to define a lateral gap 242 of at least one one-thousandth of an inch between laterally adjacent magnets 238.

Flux recircuiting receiver plate 250, also fabricated from a ferrous material such as steel, is configured as a flat plate. Receiver plate 250 further defines at its outermost extremities receiver plate side edges 156.

In use, apparatus 220 is clamped to fluid conduit in a manner similar to apparatus 120 such that longitudinal rows of magnets 238 are substantially parallel to flow axis 12 of conduit 10. Flux recircuiting receiver plate is above fluid conduit 10 and in substantial vertical registration with flux driver plate 224.

Turning now to FIG. 5, an alternate embodiment for magnetically treating fluids is illustrated as apparatus 320. Apparatus 320 is similar to apparatus 20 and like features are identified with like numbers preceded by the numeral “3.” The apparatus 320 comprises a magnetic driver 322 and a flux recircuiting receiver plate 350. Magnetic driver 322 includes a flux driver plate 324 which comprises an arcuate driver plate base 326 and driver plate sides 330 extending from arcuate driver plate base 326. arcuate driver plate base 326 is formed in an elongate semicircular fashion about longitudinal axis 312. Flux driver plate 324 is fabricated from a ferrous material such as steel. Driver plate sides 330 also define side edges 332 at the uppermost part of driver plate sides 330.

A plurality of permanent solid state magnets 338 having substantially identical field strengths are arranged in longitudinal rows, each row being affixed to the arcuate interior of driver plate base 326. Magnets 338 are also formed in an arcuate shape and have magnet sides 339. Magnet sides 339 are positioned below side edges 332 such that driver plate sides 330 extend from magnet sides 339 to side edges 332 and are defined by side dimension 331. Side dimension 331 is a minimum of one tenth of an inch. (FIG. 5 illustrates the positioning of four magnets 338 on driver plate base 326 in two parallel rows; however, this is for illustrative purposes only and is not intended to be interpreted as limiting.) Magnets 338 are formed with their respective north and south poles located at the arcuate surfaces. Magnets 338 are in a unipolar arrangement such that either all north poles or all south poles of magnets 338 are oriented axially toward longitudinal axis 312 with the opposing like poles affixed to driver plate base 326. Longitudinally arranged magnets 338 are spaced to define a longitudinal gap 340 between each of longitudinally adjacent magnets 338, and adjacent rows of magnets 338 are spaced to define a lateral gap 342 between laterally adjacent magnets 338.

Similar to apparatus 20, a flux recircuiting receiver plate 350, also fabricated from a ferrous material such as steel, has a center section 352 that defines a plane 353 and also has receiver plate sides 354 that are formed to define a receiver side angle 360 with respect to plane 353. The angle 360 so formed is not less than ten degrees and not greater than eighty-five degrees. Thus, the angle formed by center section 352 and receiver plate side 354 is between one-hundred and one-hundred-seventy-five degrees. Receiver plate sides 354 further define at their outermost extremities receiver plate side edges 356.

In use, apparatus 320 is affixed to fluid conduit 10 in the same manner as apparatus 20 with magnetic driver 322 placed below fluid conduit 10 such that the rows of magnets 338 with longitudinal axis 312 are substantially coaxial with conduit 10, and such that fluid conduit 10 is most proximate to the segments of the magnets 338 opposite from the magnet base 328. Flux recircuiting receiver plate 350 is placed over fluid conduit 10 and substantially in vertical registration with flux driver plate 324. The assembled apparatus 120 is then clamped in place on the fluid conduit 10. Similar to apparatus 20 shown in FIG. 2, when apparatus 320 is clamped to fluid conduit 10, side edge 332 and receiver plate side edge 357 are substantially parallel one with the other and define therebetween a variable gap of at least one one-thousandth of an inch similar to variable gap 58.

In operation, apparatus 320 is clamped to fluid conduit 10 as described above. Fluid is then passed through fluid conduit 10 along axis 312 to pass through the combined magnetic fields of permanent magnets 338, wherein the combined magnetic fields of magnets 338 cooperate with flux driver plate 324 and flux recircuiting receiver plate 350 to provide an advantageous magnetic flux to the fluid.

In the foregoing description those skilled in the art will readily appreciate that modifications may be made to the invention without departing from the concepts disclosed herein. Such modifications are to be considered as included in the following claims, unless these claims expressly state otherwise.

I claim:

1. An apparatus for applying a magnetic flux to a fluid flowing through a conduit along a longitudinal flow axis, said apparatus comprising:
a flux driver plate having a plate base and driver plate sides extending upwardly from said plate base defining a side angle greater than ninety degrees; and
a plurality of permanent magnets affixed in a longitudinally aligned manner to said plate base between said driver plate sides.

2. The apparatus according to claim 1 wherein said flux driver plate is fabricated from a ferrous material.

3. The apparatus according to claim 1 wherein each said permanent magnet has a substantially identical magnetic flux.

4. The apparatus according to claim 1 wherein each said permanent magnet has a north pole and a south pole and further wherein each said permanent magnet is oriented with the same pole affixed to said flux driver plate.

5. The apparatus according to claim 4 wherein longitudinally adjacent ones of said permanent magnets define a longitudinal gap therebetween.

6. The apparatus according to claim 5 wherein said longitudinal gap is a minimum of one one-thousandth inch.

7. The apparatus according to claim 5 wherein said side angle defined by said plate base and said driver plate side is not less than ninety-five degrees and not greater than one-hundred-seventy five degrees.

8. The apparatus according to claim 7 wherein said plurality of longitudinally arranged permanent magnets are further arranged in a plurality of laterally adjacent rows.

9. The apparatus according to claim 8 wherein laterally adjacent ones of said rows of said permanent magnets define a lateral gap therebetween.

10. The apparatus according to claim 9 further including a flux recircuiting receiver plate positioned over said permanent magnets and substantially in vertical registration with said flux driver plate.

11. The apparatus according to claim 10 wherein said flux recircuiting receiver plate is fabricated from a ferrous material.

12. The apparatus according to claim 7 further including a flux recircuiting receiver plate positioned over said permanent magnets and substantially in vertical registration with said flux driver plate, said receiver plate comprising:
a center section; and
receiver plate sides depending downwardly from said center section and defining a receiver side angle therewith.

13. The apparatus according to claim 12 wherein said receiver side angle defined by said center section and said receiver plate side is not less than one-hundred degrees and not greater than one-hundred-seventy five degrees

14. The apparatus according to claim 13 wherein said receiver plate side defines an outermost receiver plate side edge and said driver plate side defines a driver plate side edge and further wherein said receiver plate side edge and said driver plate side edge define a variable gap therebetween.

15. An apparatus for applying a magnetic flux to a fluid flowing through a conduit along a longitudinal flow axis, said apparatus comprising:
a flux driver plate having a plate base and a magnet base extending from each side thereof defining a magnet base angle therebetween and a driver plate side extending from a side of said magnet base opposite from said plate base defining a side angle therebetween wherein each of said magnet base angle and said side angle are greater than ninety degrees; and
a plurality of permanent magnets affixed in a longitudinally aligned row to each magnet base between said driver plate sides.

16. The apparatus according to claim 15 wherein each said permanent magnet has a north pole and a south pole and further wherein each said permanent magnet is oriented with the same pole affixed to said flux driver plate.

17. The apparatus according to claim 16 further including a flux recircuiting receiver plate fabricate from a ferrous material and positioned over said permanent magnets and substantially in vertical registration with said flux driver plate, said flux recircuiting receiver plate comprising:
a center section; and
receiver plate sides depending downwardly from said center section and defining a receiver side angle therewith.

18. The apparatus according to claim 17 wherein said receiver side angle defined by said center section and said receiver plate side is not less than one-hundred degrees and not greater than one-hundred-seventy five degrees.

19. The apparatus according to claim 17 wherein said receiver plate side defines an outermost receiver plate side edge and said driver plate side defines a driver plate side edge and further wherein said receiver plate side edge and said driver plate side edge define a variable gap therebetween.

20. A method for magnetically treating a fluid flowing through a fluid conduit, said method comprising the steps of:
arranging a plurality of permanent magnets of substantially equal flux in a longitudinally aligned row with like poles oriented in the same direction;
affixing the row of permanent magnets to a base plate of a flux driver plate and forming sides of the flux driver plate at an angle greater than ninety degrees with respect to the base plate;
aligning the longitudinally affixed magnets with the fluid conduit;
placing the affixed magnets proximate to the fluid conduit.

21. The method according to claim 20 wherein said arranging step includes a sub-step of longitudinally separating adjacent ones of the magnets to define a longitudinal gap therebetween.

22. The method according to claim 21 wherein said arranging sub-step includes longitudinally separating adjacent ones of the magnets with a minimum one one-thousandth inch gap therebetween.

23. The method according to claim 21 adding after said placing step a step of:
registering a ferrous flux recircuiting receiver plate over the fluid conduit, longitudinally aligned magnets, and flux driver plate.

24. The method according to claim 23 adding after said registering step a step of:
separating side edges of the recircuiting receiver plate from side edges of the flux driver plate to define a variable gap therebetween.

25. The method according to claim 24 wherein said separating step includes separating the recircuiting plate from the side edges of the flux driver plate with a minimum one one-thousandth inch gap therebetween.
